(19) United States
(12) Patent Application Publication
(10) Pub. No.: US 2023/0316120 A1
(43) Pub. Date: Oct. 5, 2023

(54) QUANTUM SIMULATION WITH TRAPPED IONS IN A GRADIENT FIELD

(71) Applicant: YEDA RESEARCH AND DEVELOPMENT CO., LTD., Rehovot (IL)

(72) Inventors: Roee OZERI, Rehovot (IL); Tom MANOVITZ, Rehovot (IL); Yotam SHAPIRA, Rehovot (IL); Nitzan AKERMAN, Rehovot (IL); Adiel STERN, Rehovot (IL)

(73) Assignee: YEDA RESEARCH AND DEVELOPMENT CO., LTD., Rehovot (IL)

(21) Appl. No.: 17/999,934

(22) PCT Filed: Jun. 3, 2021
(86) PCT No.: PCT/IL2021/050655

§ 371 Date: Nov. 28, 2022

(30) Foreign Application Priority Data
Jun. 3, 2020 (IL) 275099

(51) Int. Cl. G06N 10/20; G06N 10/40

(52) U.S. Cl. CPC G06N 10/20; G06N 10/40

(57) ABSTRACT

Method and apparatus for quantum simulation, based on a linear chain of ions. A gradient field is imposed to break the symmetry of the ion chain, and bichromatic driving fields are applied to bridge the energy gaps induced by the gradient field and thereby establish resonance couplings among the ions according to their relative positions in the gradient field. The combination of the gradient field and the bichromatic driving fields implement excitation hopping to simulate a variety of topologies according to higher¬dimensional Hamiltonians and boundary conditions, including ring, torus, Mobius strip configurations, as well as topologies with periodic boundary conditions. In particular synthetic gauge fields allow simulation of magnetic flux.

### FIELD OF THE INVENTION

The present invention relates to the simulation of complex processes, systems, and materials by arrangements of physical devices and components to imitate the behavior and properties thereof. In particular, the present invention relates to the use of trapped ions configured as quantum-mechanical qubits in performing quantum simulations.

### BACKGROUND OF THE INVENTION

Progress in a broad range of scientific and technological fields is hampered by the difficulty of understanding and predicting the behavior of complex systems. Classical computing devices have limited abilities to simulate the behavior of highly complex systems, so increased attention is now being focused on quantum simulators.

Although quantum simulation is related to quantum computing, it is far easier and less costly to implement in many practical applications. Quantum simulation offers reduced system complexity, avoids the high engineering cost of universal gates and fault-tolerant architecture to compensate for fidelity loss, uses much smaller qubit arrays, and does not require the development and debugging of complex algorithms in order to accurately and faithfully represent target models.

Preferred platforms for quantum simulation rely on ion chains in a linear RF trap. Such an arrangement features long coherence times and high operational fidelity. Unfortunately, however, the scope of models which such simulators can currently accommodate is restricted because of limitations in managing and configuring the ion chain. In particular, as currently-implemented, ion chains are inherently open-ended 1-dimensional arrays, placing geometric limitations on the ability to model in higher dimensions. In addition, linear trapped ion simulators also currently lack the ability to simulate magnetic flux, an important factor in many interactions and physical phenomena. It would therefore be highly desirable to have trapped ion simulators with expanded capabilities that overcome these restrictions, for implementing more advanced modeling of a broader range of complex systems, especially in higher-order geometries and with varied topologies. These goals are attained by embodiments of the present invention.

### SUMMARY OF THE INVENTION

Embodiments of the present invention provide trapped ion chains in the presence of a gradient field to break the symmetry of the chain, which in combination with an appropriately-configured set of bichromatic uniform global driving fields significantly expands the range of models that can be quantum-simulated.

Certain embodiments of the invention provide static gauge fields in the ion chain, while other embodiments provide time-varying fields. This supports versatile coupling geometries and topologies for ion chain connectivities having a variety of topology and features, such as closed boundary conditions and higher-dimensional Hamiltonians. Further embodiments provide efficient scaling to larger numbers of ions.

Therefore, according to an embodiment of the present invention there is provided a method of quantum simulation of a model to be simulated, the method including: (a) providing a chain of trapped ions for simulating the model; (b) preparing a predetermined Hamiltonian according to the model; (c) putting the chain of trapped ions into an initial excitation state, wherein at least some of the ions are in an excited state but not all of the ions are in an excited state; (d) establishing a gradient field in the vicinity of the chain of trapped ions, wherein the gradient field alters at least one energy level to differ from an ion of the chain to another ion of the chain by at least one energy gap; (e) operating a driving laser to stimulate excitation hopping from an excited ion of the chain to another ion of the chain, wherein the driving laser provides a pulse having a bichromatic driving field pair for bridging an energy gap and thereby enabling excitation hopping in the presence of the gradient field; (f) operating a scattering laser to enable state-selective fluorescence of the ions of the chain; and (g) operating a photon detector to determine from the state-selective fluorescence which ions of the chain are in an excited state, thereby determining a state of the simulation of the model.

In addition, according to another embodiment of the present invention there is also provided an apparatus for quantum simulation of a model to be simulated, the apparatus including: (a) a chain of trapped ions for simulating the model; (b) a device for establishing a gradient field in the vicinity of the chain of trapped ions, wherein the gradient field alters at least one energy level to differ from an ion of the chain to another ion of the chain by at least one energy gap; (c) a driving laser for stimulating excitation hopping from an excited ion of the chain to another ion of the chain, wherein the driving laser is operative to provide a pulse having a bichromatic driving field pair for bridging an energy gap and thereby enabling excitation hopping in the presence of the gradient field; (d) a scattering laser for enabling state-selective fluorescence of the ions of the chain; (e) a photon detector for determining from the state-selective fluorescence which ions of the chain are in an excited state, and which is thereby operative to determine a state of the simulation of the model; and (f) a controller for controlling the apparatus, wherein the controller is operative to: (g) receive a predetermined Hamiltonian according to the model; (h) control the apparatus to: (i) put the chain of trapped ions into an initial excitation state, wherein at least some of the ions are in an excited state but not all of the ions are in an excited state; (j) establish a gradient field in the vicinity of the chain of trapped ions, wherein the gradient field alters at least one energy level to differ from an ion of the chain to another ion of the chain by at least one energy gap; (k) stimulate excitation hopping from an excited ion of the chain to another ion of the chain, (l) enable state-selective fluorescence of the ions of the chain; and (m) determine from the state-selective fluorescence which ions of the chain are in an excited state, thereby determining a state of the simulation of the model; and (n) output the state of the simulation of the model.

### BRIEF DESCRIPTION OF THE DRAWINGS

The subject matter disclosed may best be understood by reference to the following detailed description when read with the accompanying drawings in which:

FIG. 1A conceptually illustrates a typical ion chain and a corresponding energy level diagram as currently implemented, showing allowed excitation hopping according to prior art implementations.

FIG. 1B conceptually illustrates the ion chain of FIG. 1A in the presence of a gradient field, showing the suppression of excitation hopping by moving the ion transitions off-resonance.

FIG. 1C conceptually illustrates the ion chain of FIG. 1B in the presence of the gradient field, showing that coupling is reinstated by introducing a driving frequency that bridges the gap induced by the gradient between nearest neighbor ions, according to an embodiment of the present invention.

FIG. 1D conceptually illustrates the ion chain of FIG. 1B in the presence of the gradient field, showing that coupling is reinstated by introducing a driving frequency that bridges the gap induced by the gradient between next-nearest neighbor ions, according to another embodiment of the present invention.

FIG. 2A is an energy-level diagram showing bichromatic driving field pairs for bridging ion resonance differences induced by a gradient field, according to an embodiment of the present invention.

FIG. 2B conceptually illustrates the tailoring of controlled resonances to implement mixed excitation hopping to bring about a simulated topology, according to another embodiment of the present invention.

FIG. 2C conceptually illustrates a ring topology traversed by a simulated magnetic flux, as implemented by the controlled resonances according to the embodiment of FIG. 2B.

FIG. 3 is a component diagram of apparatus for performing a quantum simulation, according to an embodiment of the present invention, featuring an ion chain in a gradient field with driving, measurement, and control devices.

FIG. 4 is a flowchart of a method according to an embodiment of the present invention.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION OF THE PRESENT INVENTION

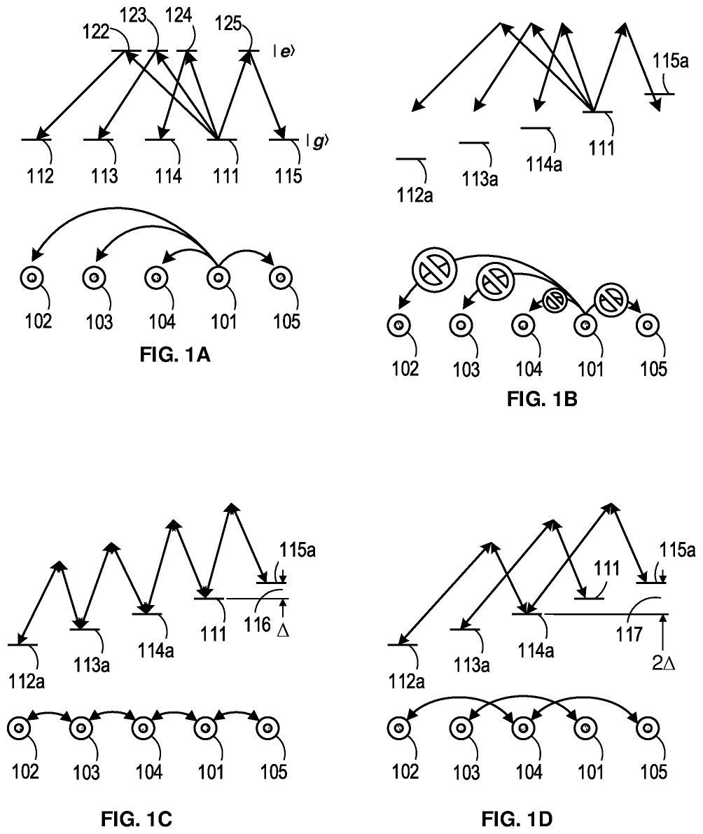

FIG. 1A conceptually illustrates a typical ion chain containing ions 101, 102, 103, 104, and 105, along with a corresponding energy level diagram according to prior art implementations. Respective ground state Ig) levels 111, 112, 113, 114, and 115, and respective excited state levels |e [symbol] are the same for each of the ions allowing excitation to hop from any one ion to any other ion, as shown in a representative case for ion 101.

FIG. 1B conceptually illustrates the ion chain 101, 102, 103, 104, and 105 of FIG. 1A in the presence of a gradient field (not shown), which alters the energy levels 111, 112, 113, 114, and 115 (FIG. 1A) to differ from one ion to another, respectively shown as 111, 112a, 113a, 114a, and 115a. In this case, the ion transitions are moved off-resonance, resulting in the suppression of excitation hopping, as shown.

FIG. 1C conceptually illustrates the ion chain 101, 102, 103, 104, and 105 of FIG. 1B in the presence of the gradient field (not shown), showing that coupling is reinstated by introducing a driving frequency that bridges a gap 116 having an energy increment induced by the gradient field between nearest neighbor ions, according to an embodiment of the present invention.

FIG. 1D conceptually illustrates the ion chain 101, 102, 103, 104, and 105 of FIG. 1B in the presence of the gradient field (not shown), showing that coupling is reinstated by introducing a driving frequency that bridges a gap 117 having an energy increment 2A induced by the gradient between next-nearest neighbor ions, according to an embodiment of the present invention.

According to various embodiments of the invention, some, but not all, of the ions in the ion chain are initialized to be in an excited state. The operations performed on the ion chain changes which ions are excited—as described herein, the bichromatic driving field stimulates excitation hopping from each excited ion to another ion (which may or may not already be in an excited state)—but does not alter the number of excited ions. Excited state hopping is bi-directional, but a preferred hopping direction can be imposed, as disclosed below for particular conditions. In particular, embodiments of the present invention provide controllable and selectable modes of excitation hopping among the ions within a trapped ion chain in a gradient field. Controllable and selectable modes include, but are not limited to nearest-neighbor hopping, next-nearest neighbor hopping, and so forth. In certain embodiments, the particular ion species is Strontium, specifically ⁸⁸Sr⁺.

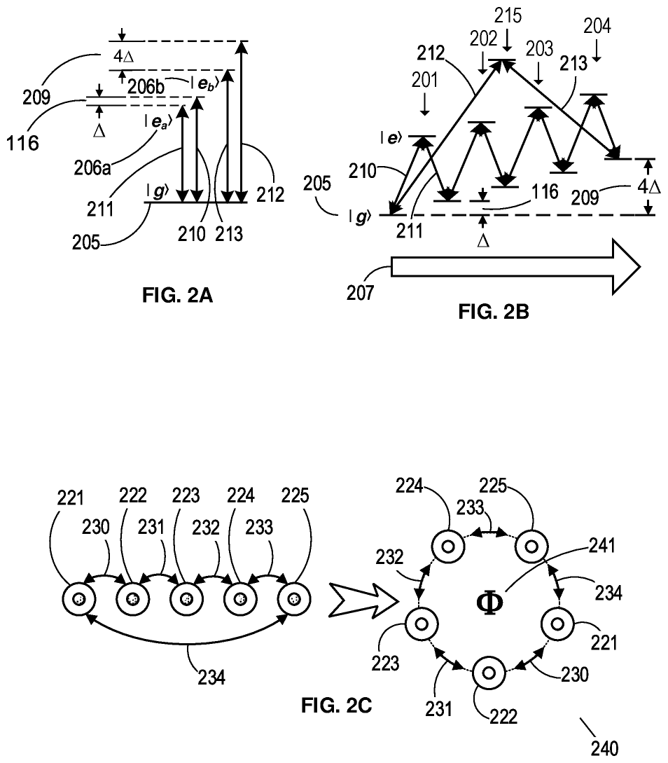

FIG. 2A is an energy-level diagram showing bichromatic driving field pair 210-211 and bichromatic driving field pair 212-213 for bridging ion resonance differences induced by a gradient field, according to an embodiment of the present invention. Bridging the gap enables excitation hopping in the presence of the gradient field. Both driving field pairs are referenced from a ground state Ig) 205. Driving field pair 210-211 has an excited state lea) 206a, having a bichromatic energy difference Δ 116; and driving field pair 212-213 has an excited state |e_{b} [symbol] 206b, having a bichromatic energy difference 4Δ 209. Bichromatic energy difference 209 is 4Δ in this non-limiting example, because there are five ions in the ion chain of this example, having a maximum energy difference of 4Δ.

FIG. 2B conceptually illustrates the tailoring of controlled resonances to implement mixed excitation hopping that bring about a simulated topology, according to another embodiment of the present invention. In the presence of a gradient field 207, the ground state energies of the ions in the chain are displaced, as previously described. Excited states 201, 202, 203, and 204 correspond respectively to the first four ions in the chain of five ions, and have an energy difference Δ 116 from one ion to the next.

FIG. 2C conceptually illustrates the correspondence between a linear chain of ions 221, 222, 223, 224 and 225 and a simulated ring topology 240 of the same ions. Nearest-neighbor hoppings 230, 231, 232, and 233 are implemented by bichromatic transitions having energy difference Δ 116, as illustrated in FIG. 2A and FIG. 2B; and fourth-neighbor hopping 234 between ion 221 and ion 225 is implemented by the bichromatic transition having energy difference 4Δ 209, as also illustrated in FIG. 2A and FIG. 2B.

In a related embodiment, the phases of the bichromatic pairs are chosen to generate synthetic gauge fields, simulating a discrete 1-dimensional Aharonov-Bohm ring with a magnetic flux Φ 241 passing through ring 240. According to this embodiment, the Hamiltonian includes a hopping term with phase components determined by multiples of ϕ=2πΦ/N, where Nis the number of ions. The direction and velocity of the excitation hopping is determined by the sign and magnitude, respectively, of flux Φ 241. In an additional related embodiment, the ring has periodic boundary conditions for an odd number of excited ions, and aperiodic boundary conditions for an even number of excited ions.

According to a further related embodiment, magnetic flux Φ 241 supports a persistent current around the ring due to the Aharonov-Bohm effect. As the ring system evolves due to the hopping transfer of excitation states from ion to ion, a wave packet propagates around the ring at a constant velocity. For maximal velocity in the limit of large N the time for the packet to revolve around the ring is N/2Ω, where Ω is the Rabi frequency of the ion transition.

Other embodiments of the invention provide simulation of topologies including, but not limited to: a triangular spin ladder; a 2-dimensional helix on a cylinder; a 2-dimensional helix on a torus; a torus with magnetic flux across both non-simply-connected cycles of the torus; and a Möbius strip.

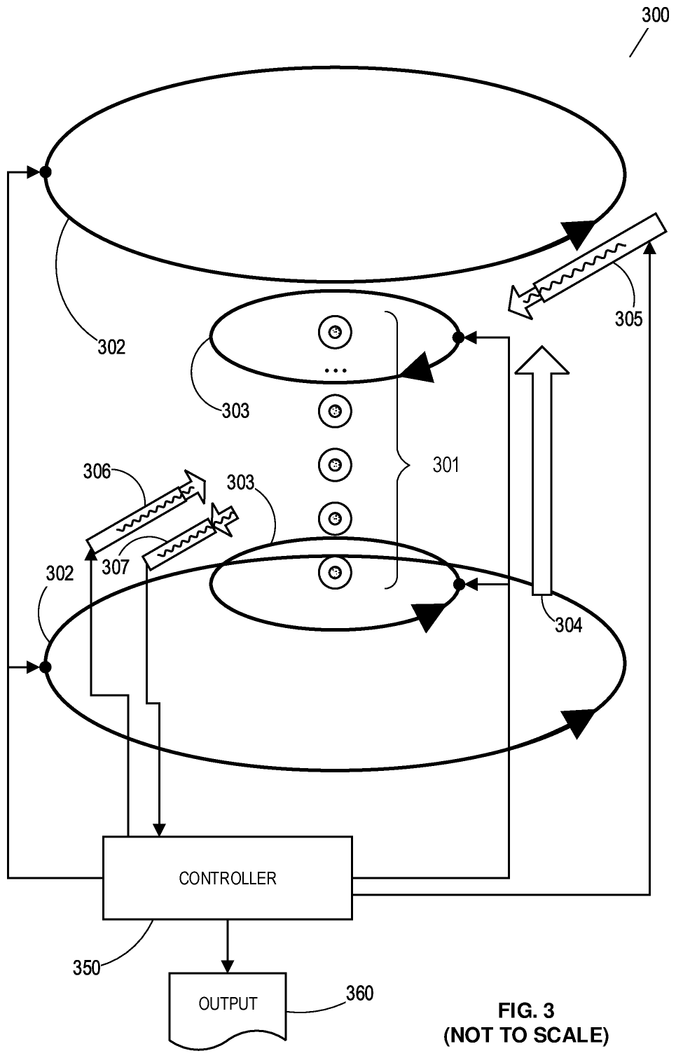

FIG. 3 is a component diagram of apparatus 300 for performing a quantum simulation, according to an embodiment of the present invention, featuring a trapped ion chain 301 (RF trap and vacuum envelope not shown) in the presence of a gradient field 304. A first magnet 302, shown as a Helmholtz coil, provides a substantially uniform magnetic field, and a second magnet 303, shown as an anti-Helmholtz coil, establishes gradient field 304 in the vicinity of the ions. A driving laser 305 provides bichromatic pulses for excitation hopping, as previously described. A scattering laser 306 enables state-selective fluorescence of the states of the individual ions of ion chain 301, in conjunction with a photon detector 307 to detect fluorescence from the ions according to the states of the individual ions and thereby determine which ions are in an excited state. In a related embodiment, photon detector 307 is a charge-coupled device (CCD), while in another embodiment photon detector is a single photon counting module (SPCM). A controller device 350 provides automated control of the operations of magnets 302 and 303, driving laser 305, scattering laser 306, and photon detector 307. Controller 305 controls the components to initialize ion chain 301 and also provides analysis of the evolving state of ion chain 301, including an output 360 of the simulation. In another related embodiment, scattering laser 306 emits radiation in the 422 nanometer range.

In still another embodiment of the present invention, driving laser 305 induces a Bloch sphere rotation on the quantum state of the ions, thereby permitting scattering laser 306 to determine other quantum properties of the ions.

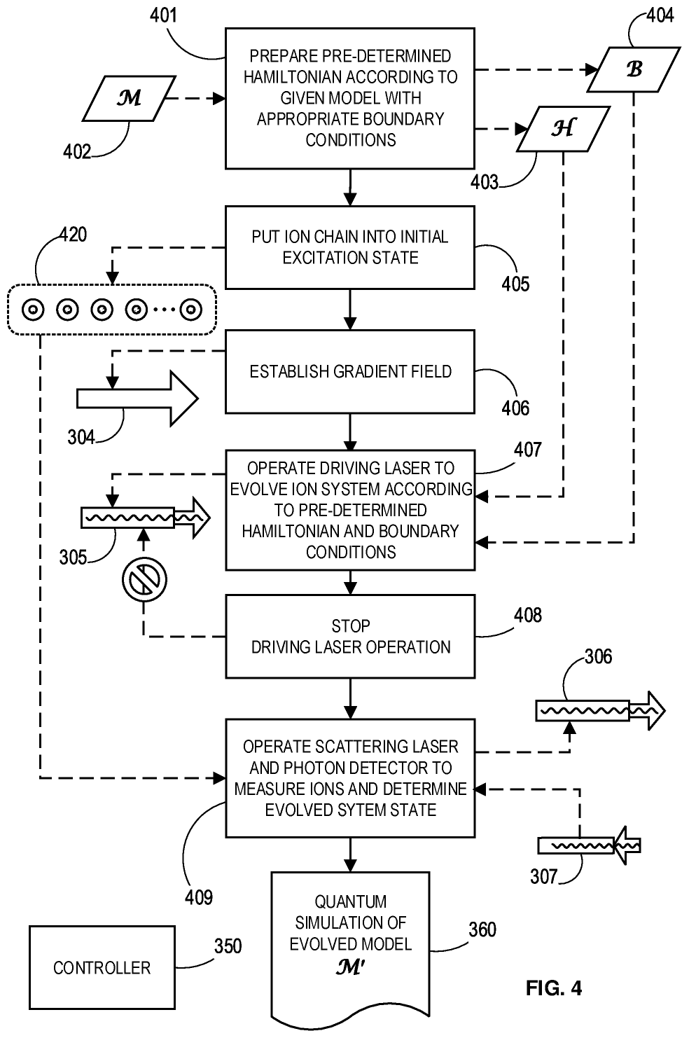

FIG. 4 is a flowchart of a method for quantum simulation, according to an embodiment of the present invention. In a step 401 a predetermined Hamiltonian 403 is prepared for a given model 402 having appropriate boundary conditions 404. Model 402 is to be quantum simulated by an ion chain 420 in gradient field 304 with the field settings for bichromatic laser 305 to as required to realize Hamiltonian 403. Accordingly, Hamiltonian 403 contains terms, including but not limited to hopping terms and phase terms, so that it corresponds to the Hamiltonian of model 402.

In a step 405 ion chain 420 is put into an initial excitation state, wherein at least some of the ions are in an excited state, but not all the ions are in an excited state. Any technique of the art for putting an ion into an excitation state is usable for this step. Then, in a step 406 gradient field 304 is established. Next, in a step 407 driving laser 305 is operated according to the parameters of predetermined Hamiltonian 403 consistent with boundary conditions 404. This will cause the excitation state of ion chain 420 to evolve in a manner that simulates the behavior that would be expected of model 402. It is once again noted that the number of excited ionic states is conserved under evolution. The distribution of the excited states, however, will change to simulate the behavior that would be exhibited by model 402.

At some point, in a step 408, driving laser 305 is stopped. Then, in a step 409, scattering laser 306 is operated to cause the ions of ion chain 420 to selectively fluoresce according to the electronic state in which they happen to be. Input from photon detector 307 then identifies which ions are in the excited state, thereby determining the state of the simulation of model 402. From this determination, an output 360 reports the simulated quantum state of model 402.

In a related embodiment, controller 350 receives a predetermined Hamiltonian and performs the rest of the steps of this method in an automated fashion.

What is claimed is:

1. A method of quantum simulation of a model to be simulated, the method comprising:
providing a chain of trapped ions for simulating the model;
preparing a predetermined Hamiltonian according to the model;
putting the chain of trapped ions into an initial excitation state, wherein at least some of the ions are in an excited state but not all of the ions are in an excited state;
establishing a gradient field in the vicinity of the chain of trapped ions, wherein the gradient field alters at least one energy level to differ from an ion of the chain to another ion of the chain by at least one energy gap;
operating a driving laser to stimulate excitation hopping from an excited ion of the chain to another ion of the chain, wherein the driving laser provides a pulse having a bichromatic driving field pair for bridging an energy gap and thereby enabling excitation hopping in the presence of the gradient field;
operating a scattering laser to enable state-selective fluorescence of the ions of the chain; and
operating a photon detector to determine from the state-selective fluorescence which ions of the chain are in an excited state, thereby determining a state of the simulation of the model.

2. The method of claim 1, wherein the gradient field is a magnetic field.

3. The method of claim 1, wherein the bichromatic driving field pair has phases to generate a synthetic gauge field.

4. The method of claim 3, wherein the quantum simulation includes simulation of a magnetic field.

5. The method of claim 1, wherein there are a plurality of energy gaps and wherein the quantum simulation includes a simulated topology.

6. The method of claim 5, wherein the simulated topology is selected from a group consisting of:
a ring;
a triangular spin ladder;
a 2-dimensional helix on a cylinder;
a 2-dimensional helix on a torus;
a torus with magnetic flux across a non-simply-connected cycle; and
a Möbius strip.

7. An apparatus for quantum simulation of a model to be simulated, the apparatus comprising:
a chain of trapped ions for simulating the model;
a device for establishing a gradient field in the vicinity of the chain of trapped ions, wherein the gradient field alters at least one energy level to differ from an ion of the chain to another ion of the chain by at least one energy gap;
a driving laser for stimulating excitation hopping from an excited ion of the chain to another ion of the chain,
wherein the driving laser is operative to provide a pulse having a bichromatic driving field pair for bridging an energy gap and thereby enabling excitation hopping in the presence of the gradient field;
a scattering laser for enabling state-selective fluorescence of the ions of the chain;
a photon detector for determining from the state-selective fluorescence which ions of the chain are in an excited state, and which is thereby operative to determine a state of the simulation of the model; and
a controller for controlling the apparatus, wherein the controller is operative to:
receive a predetermined Hamiltonian according to the model;
control the apparatus to:
put the chain of trapped ions into an initial excitation state,
wherein at least some of the ions are in an excited state but not all of the ions are in an excited state;
establish a gradient field in the vicinity of the chain of trapped ions, wherein the gradient field alters at least one energy level to differ from an ion of the chain to another ion of the chain by at least one energy gap;
stimulate excitation hopping from an excited ion of the chain to another ion of the chain,
enable state-selective fluorescence of the ions of the chain; and
determine from the state-selective fluorescence which ions of the chain are in an excited state, thereby determining a state of the simulation of the model; and
output the state of the simulation of the model.

8. The apparatus of claim 7, wherein the device for establishing the gradient field is a magnet, and wherein the gradient field is a magnetic gradient field.
